(19) United States
(12) Patent Application Publication
(10) Pub. No.: US 2011/0239149 A1
(43) Pub. Date: Sep. 29, 2011

(54) TIMELINE CONTROL

(75) Inventors: Rhetto S. Lazo, San Jose, CA (US); Joseph P. McLaughlin, Seattle, WA (US); Neil M. Cueto, Seattle, WA (US); Karen L. Davis, Seattle, WA (US); Larry R. Butcher, Seattle, WA (US); Christopher C. Barnes, Seattle, WA (US); Chunkwok Lee, Santa Clara, CA (US); Mark Anthony DeGuzmanGamab, San Jose, CA (US); Paul N. Rybicki, San Francisco, CA (US); Barry W. Lai, San Francisco, CA (US)

(73) Assignee: MICROSOFT CORPORATION, Redmond, WA (US)

(21) Appl. No.: 13/029,943

(22) Filed: Feb. 17, 2011

Related U.S. Application Data
(60) Provisional application No. 61/317,214, filed on Mar. 24, 2010.

(51) Int. Cl. G06F 3/048

(52) U.S. Cl. 715/772

(57) ABSTRACT

Timeline control techniques are described. In one or more implementations, a timeline is displayed that is divided into a plurality of intervals, each of which corresponds to a respective period of time. Responsive to selection of one of the plurality of intervals, a control is displayed within the selected interval that is scrollable within an area defined by the selected interval to move between content that is associated at corresponding points in time at a scrolling speed that is based at least in part on an amount of the content that is associated with the interval.

### RELATED APPLICATIONS

This application claims priority under 35 U.S.C. Section 119(e) to U.S. Provisional Patent Application No. 61/317,214, filed Mar. 24, 2010 and titled “Mobile Communications Device Timeline Control,” the entire disclosure of which is hereby incorporated by reference in its entirety.

### BACKGROUND

With the ever increasing prevalence of computing devices in everyday modern life, users are confronted with an ever increasing amount of content. For example, users may generate a significant amount of this content themselves, such as by taking photos, writing messages, and so on. Likewise, a user may be sent a significant amount of content every day, including messages, photos, status updates, and so forth. Consequently, if may difficult for a user to navigate through this content to locate a particular item of interest, especially over a significant period of time.

### SUMMARY

Timeline control techniques are described. In one or more implementations, a timeline is displayed that is divided into a plurality of intervals, each of which corresponds to a respective period of time. Responsive to selection of one of the plurality of intervals, a control is displayed within the selected interval that is scrollable within an area defined by the selected interval to move between content that is associated at corresponding points in time at a scrolling speed that is based at least in part on an amount of the content that is associated with the interval.

In one or more implementations, portions of content are selected that are associated with a period of time associated with one of a plurality of intervals of a timeline using one or more rules. The selected portions are displayed concurrently with the timeline, the timeline including a plurality of indications along which indicate that content is associated with a corresponding point in time defined by the timeline.

In one or more implementations, one or more computer-readable media comprise instructions stored thereon that, responsive to execution by a computing device, causes the computing device to perform operations comprising: displaying portions of messages, images, and contacts selected from content concurrently with a timeline, the timeline including a plurality of indications along which indicate that content is associated with a corresponding point in time defined by the timeline; and displaying a control that is scrollable at different speeds through the intervals based on an amount of content that is associated with the interval.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ timeline techniques.

FIG. 2 is an illustration of a user interface in an example implementation showing a timeline that includes a control to navigate through content.

FIG. 3 depicts example implementations of the timeline of FIG. 2 as selecting different scales.

FIG. 4 depicts an example implementation in which a scroll speed of a control that may be used to scroll through content in a timeline is adjusted based on an amount of content associated with a respective interval of time represented by the timeline.

FIG. 5 is a flow diagram depicting a procedure in an example implementation in which content is selected for concurrent display with a timeline based on one or more rules.

FIG. 6 is a flow diagram depicting a procedure in an example implementation in which a scrolling speed is adjusted based on an amount of content associated with an interval in a timeline.

FIG. 7 is an illustrated of an example device that is operable to perform techniques described herein.

### DETAILED DESCRIPTION

### Overview

Users may have a significant amount of content available via a wide variety of different devices, e.g., locally on a mobile communications device, via a cloud service, and so on. Typically this content is shown as a laundry list of the content through which is user is forced to navigate to find content of interest, which may be time consuming and lead to user frustration.

In implementations, a timeline control provides users with the ability to explore various periods of a content history. For example, the user may pick the period (e.g., specify an amount of time) and choose a scale at which to show the content along a timeline. This guides users to periods of activity to review instead of forcing them to scroll through large periods of inactivity.

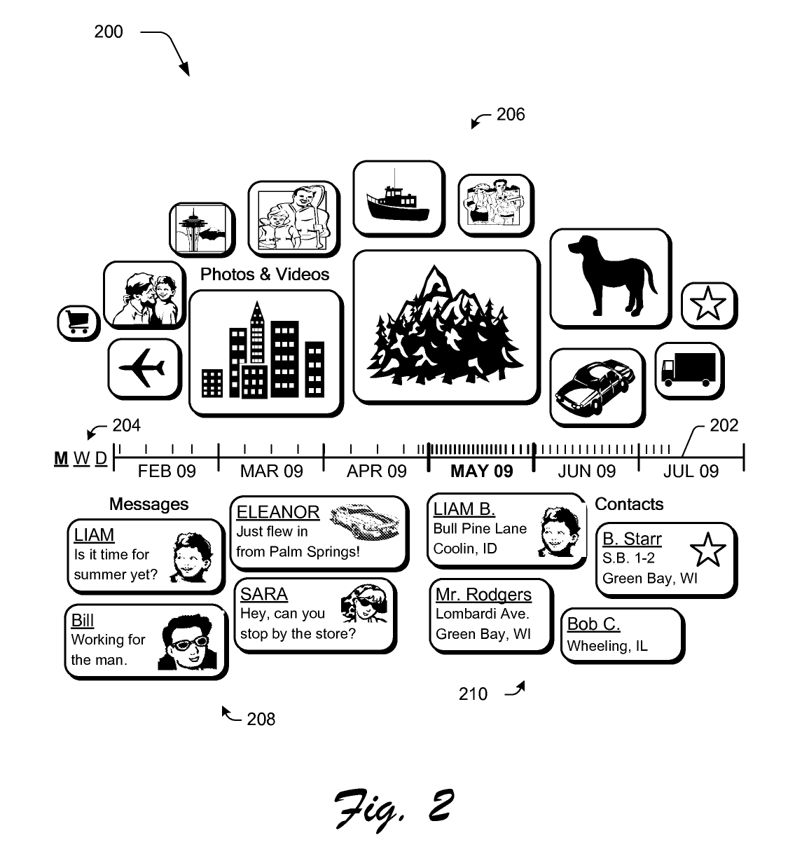

In addition to this, the techniques described herein may use metadata from the content to choose which summary content is to be displayed for the period chosen from the timeline. By combining metadata from different objects, the summary items shown have a higher probability of interest to a user, further discussion of which may be found in relation to FIG. 2.

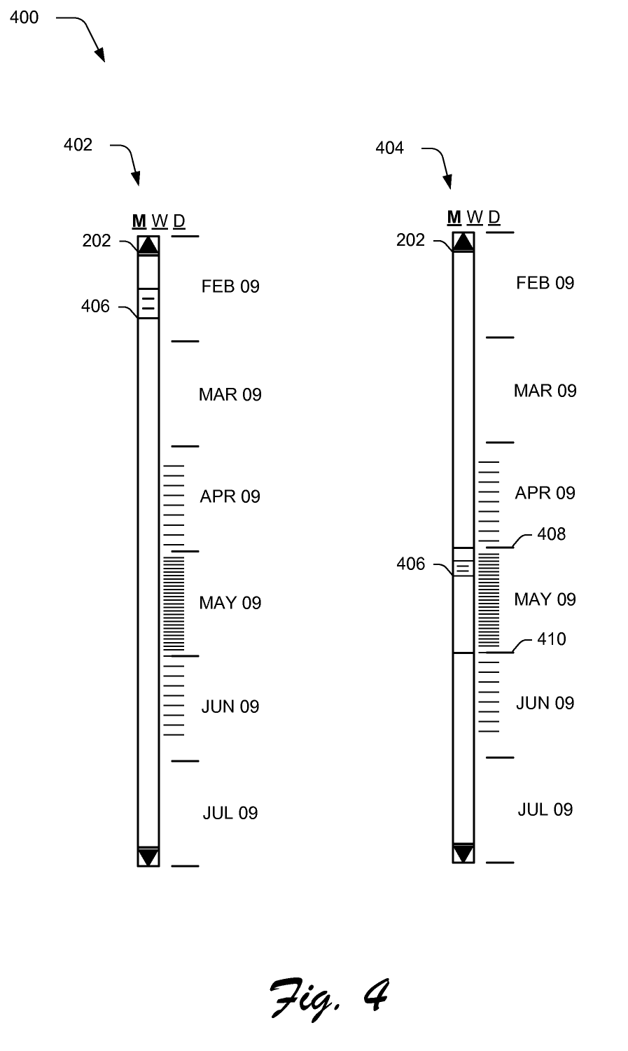

Additionally, the techniques described herein may be configured to aid navigation through the timeline. For example, the timeline may include a control to scroll through different points in time represented by the timeline to navigate to content associated with that time. Scrolling speed through the intervals may be based at least in part on an amount of content included in the interval, further discussion of which may be found in relation to FIG. 4.

In the following discussion, an example environment is first described that is operable to perform timeline techniques described herein, along with example user interfaces that may be output using the environment. Example procedures are then described which may be performed using the example environment and user interfaces, as well as in other environments and user interfaces. Consequently, performance of the example procedures should not be limited to the example environment and the example environment is not limited to performing the example procedures.

### Example Environment

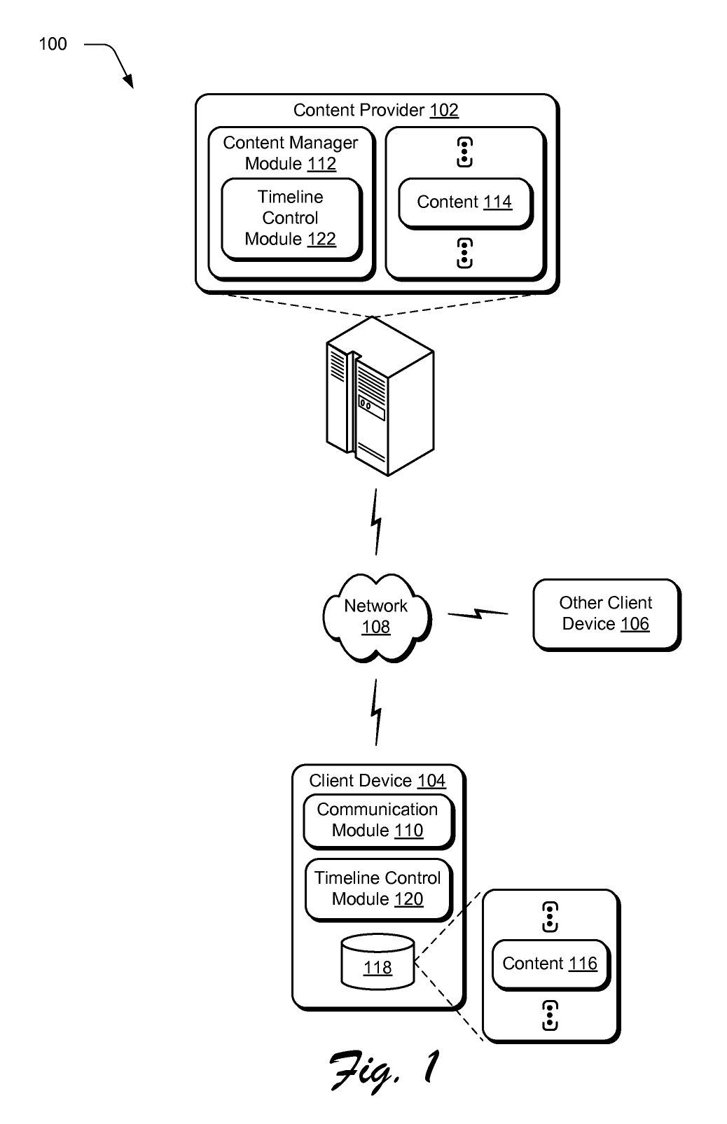

FIG. 1 is an illustration of an environment 100 in an example implementation that is operable to employ techniques described herein. The illustrated environment 100 includes a content provider 102, a client device 104, and another client device 106 that are illustrated as being communicatively coupled, one or another, via a network 108. The content provider 102, client device 104, and the other client device 106 may be implemented using a variety of different computing devices.

For example, the computing devices may be configured as a computer that is capable of communicating over a network 108, such as a desktop computer, a mobile station, an entertainment appliance, a set-top box communicatively coupled to a display device, a wireless phone, a game console, and so forth. Thus, a computing device may range from full resource devices with substantial memory and processor resources (e.g., personal computers, game consoles) to a low-resource device with limited memory and/or processing resources (e.g., traditional set-top boxes, hand-held game consoles). Additionally, a computing device may be representative of a plurality of different devices, such as multiple servers utilized by a business to perform operations (e.g., server farm of the content provider 102), a remote control and set-top box combination, an image capture device and a game console configured to capture gestures, and so on.

A computing device may also include an entity (e.g., software) that causes hardware of the computing device to perform operations, e.g., processors, functional blocks, and so on. For example, the computing device may include a computer-readable medium that may be configured to maintain instructions that cause the computing device, and more particularly hardware of the computing device to perform operations. Thus, the instructions function to configure the hardware to perform the operations and in this way result in transformation of the hardware to perform functions. The instructions may be provided by the computer-readable medium to the computing device through a variety of different configurations.

One such configuration of a computer-readable medium is signal bearing medium and thus is configured to transmit the instructions (e.g., as a carrier wave) to the hardware of the computing device, such as via the network 108. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be configured to include multiple networks.

The client device 104 is illustrated as including a communication module 110. The communication module 110 is representative of functionality of the client device 104 to communicate over the network 108. For example, the communication module 110 may employ browser or other functionality to communicate with a content manager module 112 of the content provider 102 to access content 114. The content provider 102 may be configured as a variety of different services that involve content, such as a “sky drive,” photo sharing service, social network, and so on.

The client device 104 may also have access to a variety of content 116 from local storage 118. For example, the content 116 may be configured as documents, messages (e.g., emails, texts, status updates), images, contacts (e.g., contact information), and so forth. The client device 104 may also have access to content from other client device 106, which may be associated with the user or other users. Consequently, a user may have access to a wide variety of content that may be spread across a wide variety of devices.

In this example, the client device 104 employs a timeline control module 120 that is representative of functionality to output a user interface that includes a timeline. The timeline, for instance, may serve as a navigation tool in a user interface such that a user may navigate through content that is related based on date. Further, the content represented in the timeline may include content from a variety of different locations, such as content 116 local to the client device 104, content available from another client device 106, content 114 available from a content provider 102, and so on. In this way, a user may readily navigate through content to locate a particular item of interest. Although functionality of the timeline control module 120 is illustrated as being implemented at the client device 104, this functionality may be implemented in a wide variety of ways. For example, the functionality may be incorporated at the content provider 102 as part of a service as illustrated by the timeline control module 122, may be divided between the client device 104 and the content provider 102, and so on.

Generally, any of the functions described herein can be implemented using software, firmware, hardware (e.g., fixed logic circuitry), manual processing, or a combination of these implementations. The terms “module” and “functionality” as used herein generally represent hardware, software, firmware, or a combination thereof. In the case of a software implementation, the module, functionality, or logic represents instructions and hardware that performs operations specified by the hardware, e.g., one or more processors and/or functional blocks.

FIG. 2 is an illustration of a user interface 200 in an example implementation showing a timeline that includes a control to navigate through content. The timeline 202 includes a plurality of intervals, which in this instance are months although other intervals of time are also contemplated and selectable, such as weeks and days 204. Each of the intervals is labeled accordingly along with bounding lines that indicate respective boundaries of the identified interval. In an implementation, the bounding lines may be selected and repositioned (e.g., click and drag) to further define an interval, expand a view of an interval, and so on.

The timeline 202 also includes a plurality of indications to represent that content is available and associated with a respective period of time represented by the timeline 202. These indications are represented as lines disposed above the timeline 202 in the illustrated example although other implementations are also contemplated. In this way, a user may readily view which intervals of the timeline 202 are associated with content and how that content relates temporality, even if the content expands across the border of different intervals of time. As illustrated, for instance, the interval “May 09” is selected, the concentration of content is greatest around that period of time, such as due to photos taken and messages received after a birth of a child. In this way, a user may readily locate a time period of interest and view the relation of the content to that time period.

The timeline 202 is also illustrated as displayed concurrently with portions of content represented by the timeline. In the illustrated example, a photos and videos group 206 is shown above the timeline 202 that includes portions of video and/or photos that correspond to a selected interval of time. For example, this group may leverage a cache of online photos and metadata locally on the client device 104 for a predefined amount of time (e.g., for several days) and include them in the view. A messages group 208 is also illustrated that includes messages from the selected interval of time, along with a contacts group 210 that references contacts that are associated with the interval.

A variety of different rules that leverage metadata may be employed by the timeline control module 120 to determine which portions of content are to be displayed concurrently with the timeline 202. For example, users may store a large amount of content into a storage source, e.g., over a cloud at the content provider 102, locally in local storage 118, and so on as previously described. Based on the connections between content that may be inferred by the metadata associated with the content, a selection of portions of content may be made by the timeline control module 120 that has an increased likelihood of being of interest to the user. In this way, the user is provided with an interactive timeline control to both navigate and refine the selected content returned.

The timeline control module 120 may also leverage rules that involve “intelligent” selection of summary content based on interactions between content. For example, the rules may state that messages sent to friends have increased relevance over messages that are sent to unknown contacts, photos posted to a social network are more important than photos taken but rarely viewed, and so on. Additionally, these rules may leverage connections between various types of content, such as to include contacts that are associated with messages that are to be displayed.

Further, the timeline control module 120 may configure the timeline 202 to use visual cues to show where summary data is obtained if a selected state does not contain data. For example, the areas in which portions of content are displayed in the user interface 200 may be standardized, such that a certain amount of content is used to fill those portions. If a particular interval that is selected is not associated with a sufficient amount of content, content from adjacent intervals may be used. Additionally, visual cues may be used to indicate that this happened, such as bolding of the primary interval and graying of adjacent intervals with corresponding borders around the associated portions of the content in the user interface 200, and so on. Yet further, the timeline control module 120 may configure the timeline to employ multiple axes to allow users fine-grained control of what summary content is displayed.

In one or more implementations, the user interface is configured to include a photos summary area containing portions of thirteen photos, a messaging summary area containing portions of eight messages, a contacts summary area containing portions of seven contacts, and a timeline divided into ten intervals, which may be set to day, week, or month. As stated above, the timeline control module 120 may employ rules to determine which content is to be displayed in the user interface 200. For example, the timeline control module 120 may employ a “latest mode” in which the most recent content is shown, an “exploring mode” where users are shown a selection of content from the selected period, and so on.

In the latest mode, users may be shown content in reverse chronological order, and enough content may be “pulled from the cloud” and elsewhere to fill the portion in the user interface 200. In the exploring mode, the timeline control module 120 may take the selected interval chosen by the user and perform the following. If there is enough content to fill the portions, the timeline control module 120 may summarize this content based on a set of rules to determine relative importance, and summarize the data for that period. The timeline may also reference the section selected by the user, such as through bolding as illustrated. If there is not enough content to fill the portions from the selected interval, the timeline control module 120 may expand the interval chosen to include enough content to fill the portions. This may be denoted by extending the selection so the user understands that the user may refine their selected area to see more content.

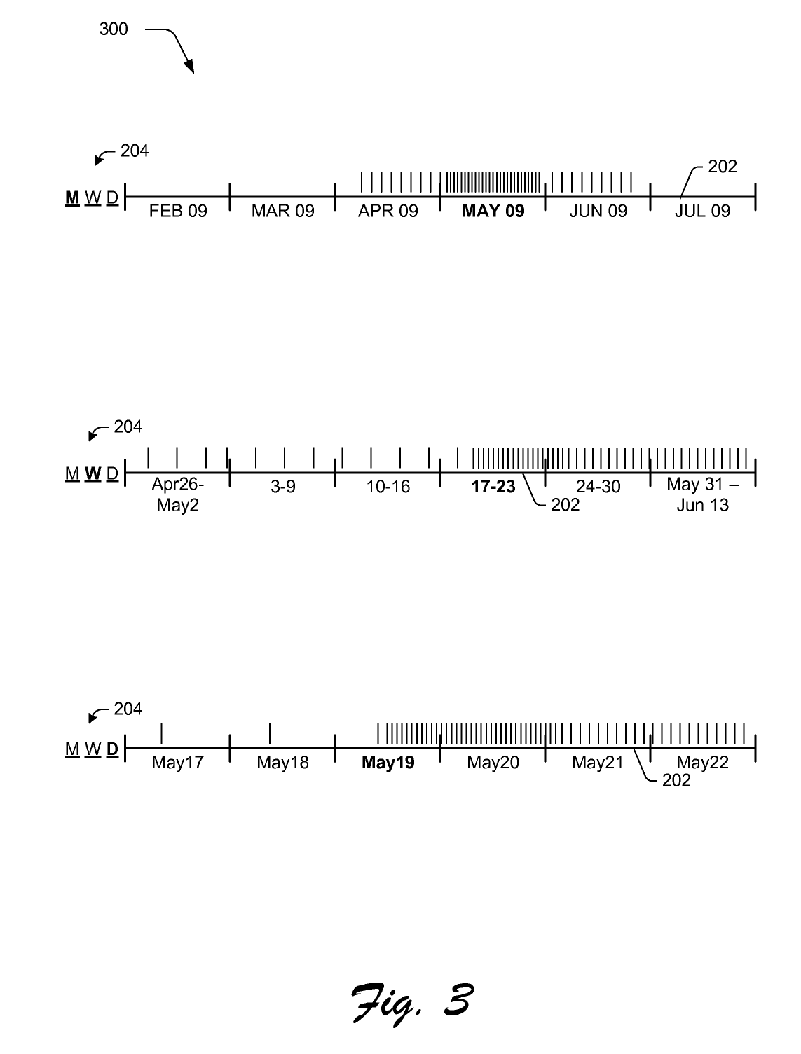

FIG. 3 depicts example implementations 300 of the timeline 200 of FIG. 2 as selecting different scales. Upon selection of a scale, such as month, week, and day as shown in this example the indications of “where” the content may be located may be repositioned along the timeline 202. Additionally, the portions used to summarize the content 202 shown in FIG. 2 may be repopulated.

When switching the scales, for instance, the timeline may be positioned to maintain a selection point of the timeline 200. For example, while in a month view, a user selection may involve a particular month, such as MAY 09. If the user selects a week view, May 17-23 is the middle week, so the new date under the selection would be the week of May 17-23. If the user then selects a day view, the module may determine that the middle date of the week is May 19 and populate it under the selected portion, e.g., the bolding in this example. Navigating back “up” may be performed using similar techniques.

Navigating the selected portion (e.g., moving the bolded area through a click and drag) may also be used to navigate forward or backward through dates.

Variable speeds may also be applied for scrolling. For example, units used to scroll to increase, e.g., scrolling at 1x, then 2x speed, may be based on how long a selection input is maintained by a user, e.g., how long a button of a mouse is pressed. Other techniques may also be performed to permit “fine” navigation through content, further discussion of which may be found in relation to the following figure.

FIG. 4 depicts an example implementation 400 in which a scroll speed of a control that may be used to scroll through content in a timeline is adjusted based on an amount of content associated with a respective interval of time represented by the timeline. This example implementation 400 is illustrated through first and second stages 402, 404.

At the first stage, a control 406 is illustrated with the timeline 202 that is configured to indicate a particular point in time represented by the timeline 202. The control 406, for instance, may be moved through a “click-and-drag” operation, repositioned with a “click” or other selection in a desired interval, “tabbed” using a tab button, moved using arrows, and so on.

In this example, a scrolling speed and size of the control 406 are adjusted based on an amount of content associated with an interval, at which, the control 406 is positioned. For example, as shown in the first stage 402 the control 406 is positioned at an interval that is not associated with content. Accordingly, a size of the control 406 is larger and a scroll speed is greater such that control 406 may be moved more quickly through the interval as opposed to the example shown in the second stage 404.

In the second stage 404, the control 406 is positioned at an interval that is associated with a large amount of content. To enable a finer degree of selection, the control 406 is shown as smaller and a scroll speed is reduced such that the control 406 may be moved with greater detail. In this way, a user is provided with a level of control that is appropriate for the amount of content through which the user is to navigate. A variety of other techniques may also be employed to gain a greater level of control. For example, one or more of the boundaries 408, 410 of the interval may be repositioned (e.g., moved “out” or “in”) to view the interval in greater or lesser detail, respectively. A variety of other examples are also contemplated without departing from the spirit and scope thereof.

### Example Procedures

The following discussion describes timeline control techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-4.

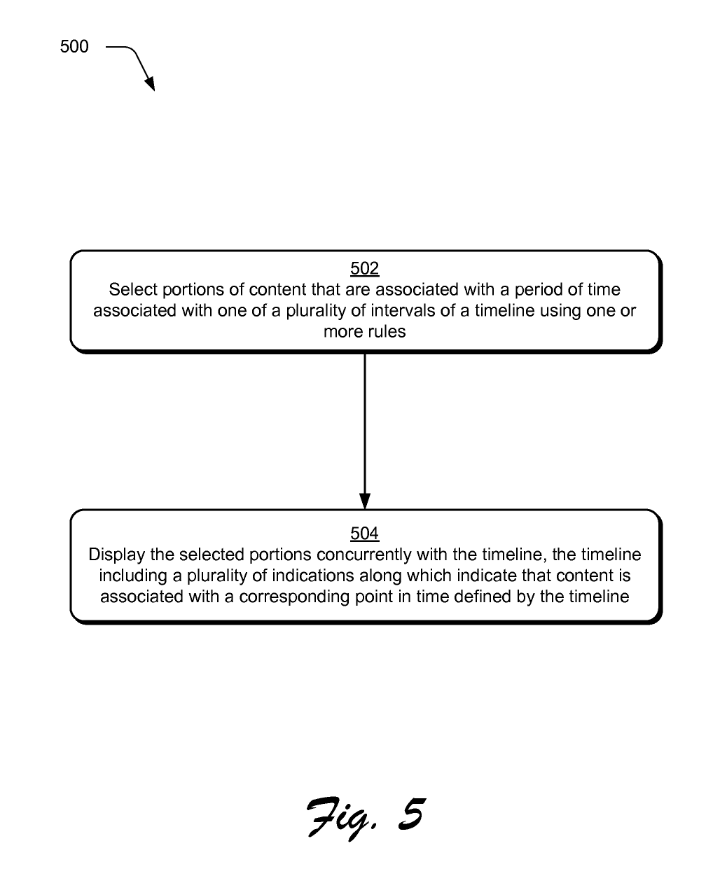

FIG. 5 depicts a procedure 500 in an example implementation in which content is selected for concurrent display with a timeline based on one or more rules. Portions are selected of content that are associated with a period of time associated with one of a plurality of intervals of a timeline using one or more rules (block 502). The rules, for instance, may leverage metadata associated with content, through which, a timeline is configured to navigate. The rules, for instance, may specify that messages to or from “friends” (e.g., in a social network service) are to be given priority over messages from other users. Additionally, the rules may specify that contact information for those friends is also to be displayed in the user interface for that portion. Other rules are also contemplated, such as to select images for viewing based on amount of times viewed, whether the image was communicated to someone else, amount of interaction with the image, and so on.

The selected portions are displayed concurrently with the timeline, the timeline including a plurality of indications along which indicate that content is associated with a corresponding point in time defined by the timeline (block 504). As shown in FIG. 2, for instance, the timeline 202 may be associated with indications (illustrated as hash marks) that indicate “where” content is located, i.e., at what point in time along the timeline 202.

The timeline 202 may also be associated with portions that are configured to summarize the content from the selected interval. For example, the portions may have different sizes as shown in FIG. 2 as portions that are used to fill those sizes may be based on likelihood of being of interest to the user and/or representative of the interval. Images, for instance, may be prioritized based on an amount of interaction previously performed with the respective images and then ordered in the portions from largest to smallest to reflect this priority. Additionally, the rules may leverage metadata from different types of content (e.g., from images, messages, and contacts) to choose which content is to be included. In this way, the content that is used to summarize the interval may have an increased likelihood of being relevant to a user.

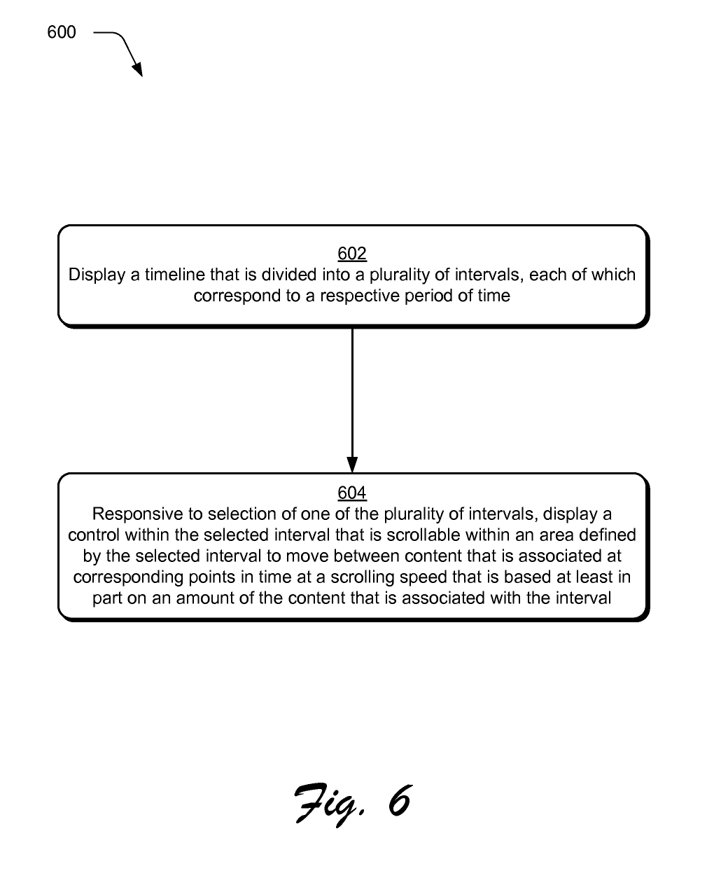

FIG. 6 depicts a procedure in an example implementation in which a scrolling speed of a control is adjusted based on an amount of content associated with an interval of a timeline at which the control is positioned. A timeline is displayed that is divided into a plurality of intervals, each of which corresponds to a respective period of time. As shown in FIG. 3, for instance, the timeline 202 may have intervals that correspond to months, weeks, days, or other intervals of time, such as years, hours, and so forth.

Responsive to selection of one of the plurality of intervals, a control is displayed within the selected interval that is scrollable within an area defined by the selected interval to move between content that is associated at corresponding points in time at a scrolling speed that is based at least in part on an amount of the content that is associated with the interval (block 604). A user, for instance, may select an interval “MAY 09” in the timeline 202 of FIG. 2 using a cursor control device, gesture, key combination (e.g., tab, arrow up or down keys, typing the name), and so on. Upon selection, the timeline control module 120 may set a scrolling speed based on an amount of content associated with the interval. For example, the timeline control module 120 may incorporate one or more thresholds to define scrolling speeds such that the speed is lessened as a number of items of associated content increases. These techniques may continue as a user navigates through intervals of the timeline 202 such that different speeds may be set for each interval, thereby giving a user a degree of control that is appropriate for the amount of content associated with the interval.

### Example Device

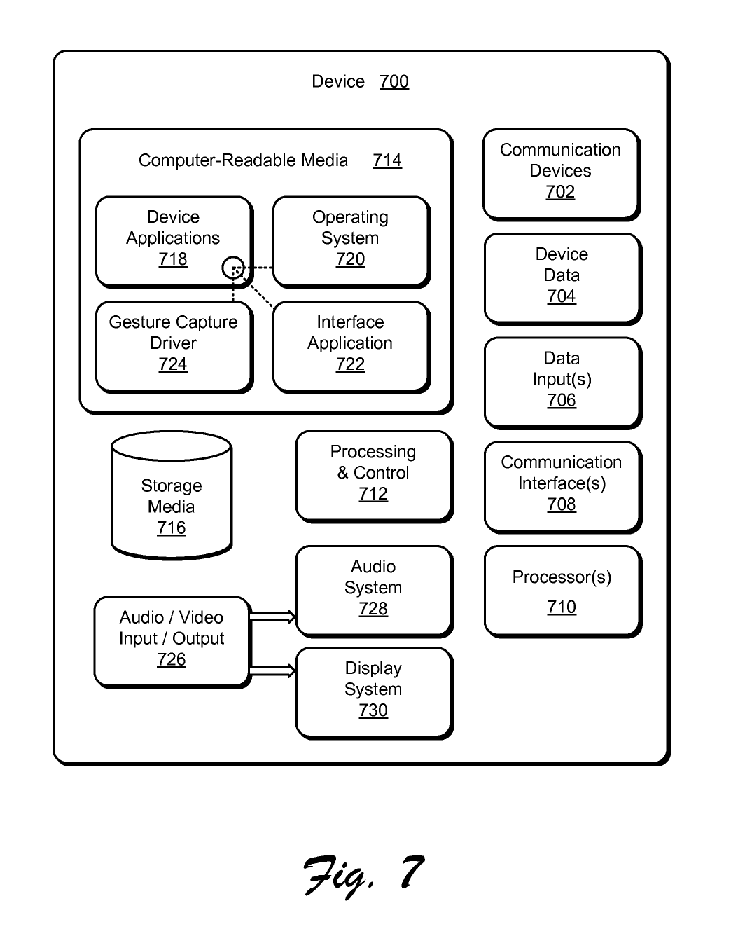

FIG. 7 illustrates various components of an example device 700 that can be implemented as any type of portable and/or computer device to implement embodiments of the timeline techniques described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data.

Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable instructions to control the operation of device 700 and to implement embodiments. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.). The device applications 718 also include any system components or modules to implement embodiments of the techniques described herein. In this example, the device applications 718 include an interface application 722 and a gesture-capture driver 724 that are shown as software modules and/or computer applications. The gesture-capture driver 724 is representative of software that is used to provide an interface with a device configured to capture a gesture, such as a touchscreen, track pad, camera, and so on. Alternatively or in addition, the interface application 722 and the gesture-capture driver 724 can be implemented as hardware, software, firmware, or any combination thereof. Additionally, the gesture-capture driver 724 may be configured to support multiple input devices, such as separate devices to capture touch and stylus inputs, respectively. For example, the device may be configured to include dual display devices, in which one of the display device is configured to capture touch inputs while the other stylus inputs.

Device 700 also includes an audio and/or video input-output system 726 that provides audio data to an audio system 728 and/or provides video data to a display system 730. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
displaying a timeline that is divided into a plurality of intervals, each of which correspond to a respective period of time; and
responsive to selection of one of the plurality of intervals, displaying a control within the selected interval that is scrollable within an area defined by the selected interval to move between content that is associated at corresponding points in time at a scrolling speed that is based at least in part on an amount of the content that is associated with the interval.

2. A method as described in claim 1, wherein the scrolling speed of the control within the interval is slower than a scrolling speed for another said interval of the timeline that is associated with a lesser amount of content.

3. A method as described in claim 1, wherein one or more of the plurality of increments include indications indicating a number of items of content that correspond to the respective period of time.

4. A method as described in claim 1, wherein the selection is made by navigating the control to the selected interval.

5. A method as described in claim 4, wherein the navigating is performed by clicking the selected interval using a cursor control device or dragging the control to the selected interval.

6. A method as described in claim 1, further comprising selecting portions of the content to be displayed concurrently with the timeline, the selecting based at least in part on the selected interval.

7. A method as described in claim 6, wherein the portions of the content that are selected to be displayed are taken from messages, images, and contacts and are displayed concurrently with the timeline in a user interface.

8. A method as described in claim 6, wherein the selecting is performed such that if a threshold number of portions of the content are not available for the selected interval, at least one portion of content associated with an adjacent said interval of the timeline is selected.

9. A method as described in claim 6, wherein the selecting is performed using one or more rules such that the portions of the content that are selected are likely to be of interest of a user.

10. A method as described in claim 9, wherein at least one of the rules leverages metadata of the content that is associated with the interval.

11. A method as described in claim 1, wherein a scrolling speed through the timeline using the control is configured to use incremental increases to increase the scrolling speed.

12. A method comprising:
selecting portions of content that are associated with a period of time associated with one of a plurality of intervals of a timeline using one or more rules; and
displaying the selected portions concurrently with the timeline, the timeline including a plurality of indications along which indicate that content is associated with a corresponding point in time defined by the timeline.

13. A method as described in claim 12, wherein at least one said rule leverages metadata of the content that is associated with the interval.

14. A method as described in claim 12, wherein the selecting is performed such that if a threshold number of portions of the content are not available for the one of the plurality of intervals, at least one portion of content associated with an adjacent said interval of the timeline is selected.

15. A method as described in claim 12, wherein the selected portions have differing sizes and are prioritized based at least in part on a likelihood that the corresponding content is of interest to a user.

16. A method as described in claim 12, wherein the portions of the content that are selected to be displayed are taken from messages, images, and contacts and are displayed concurrently with the timeline in a user interface.

17. A method as described in claim 12, wherein the intervals are associated with boundaries that are moveable in response to one or more inputs to specify a corresponding period of time.

18. One or more computer-readable media comprising instructions stored thereon that, responsive to execution by a computing device, causes the computing device to perform operations comprising:
displaying portions of messages, images, and contacts selected from content concurrently with a timeline, the timeline including a plurality of indications along which indicate that content is associated with a corresponding point in time defined by the timeline; and
displaying a control that is scrollable at different speeds through the intervals based on an amount of content that is associated with the interval.

19. One or more computer readable media as described in claim 18, wherein the selected portions have differing sizes and are ordered from large to small based at least in part on a likelihood that the corresponding content is of interest to a user.

20. One or more computer readable media as described in claim 18, wherein the portions are selected for display based at least in part on commonality of respective metadata.
